(19) United States
(12) Patent Application Publication
(10) Pub. No.: US 2021/0375150 A1
(43) Pub. Date: Dec. 2, 2021

(54) On-Line Instructional System And 3D Tools For Student-Centered Learning

(71) Applicant: SARAS-3D, INC., Allentown, PA (US)

(72) Inventors: Bipin D. DAMA, Bridgewater, NJ (US); Soham PATHAK, Allentown, PA (US); Ankita SHASTRI, Orefield, PA (US); Kalpendu SHASTRI, Orefield, PA (US)

(73) Assignee: Saras 3D-, Inc., Allentown, PA (US)

(21) Appl. No.: 17/285,339

(22) PCT Filed: Oct. 21, 2019
(86) PCT No.: PCT/US2019/057289

§ 371 Date: Apr. 14, 2021

Related U.S. Application Data
(60) Provisional application No. 62/748,486, filed on Oct. 21, 2018.
(60) Provisional application No. 62/748,482, filed on Oct. 21, 2018.
(60) Provisional application No. 62/748,481, filed on Oct. 21, 2018.

(51) Int. Cl. G09B 7/00; G06F 16/27; G06Q 50/20

(52) U.S. Cl. CPC G09B 7/00; G06Q 50/20; G06F 16/27

(57) ABSTRACT

A learning platform is configured as a network element that may be accessed by a student, who interacts with various elements at the learning platform, including a knowledge base and an associated analytics module, to receive instruction across a wide range of subject matter areas. A 3D imaging system located at the learning platform interacts with the knowledge base and analytics module to create the various 3D projections as incorporated within each learning module to enhance a student's comprehension of a given topic.

### CROSS-REFERENCE TO RELATED APPLICATIONS

This application claims the benefit of the following applications: U.S. Provisional Application No. 62/748,481, filed Oct. 21, 2018; U.S. Provisional Application No. 62/748,482, filed Oct. 21, 2018; and U.S. Provisional Application No. 62/748,486, filed Oct. 21, 2018, wherein each of the above-identified applications is incorporated by reference herein.

### TECHNICAL FIELD

The present invention relates to on-line instructional systems and, more particularly, to such systems that incorporate 3D tools and analytics-based monitoring to create an individual learning environment suitable for all students, regardless of their physical location.

### BACKGROUND OF THE INVENTION

The demands on today's students and the volume of content to be learned (i.e., assimilated knowledge) are constantly increasing. At the same time, there is a need for a deeper understanding of various topics that are often relegated to a cursory presentation in a traditional classroom setting. Moreover, the access to a quality education is limited and uneven worldwide, even in the presence of current global communication network capabilities. A toll such as “distance-learning” is helpful in some circumstances, but has not been found to be the break-through technology to raise the standard of academic instruction in most circumstances.

In particular, much of the content presented in a distance-learning environment is necessarily constrained into a flat, two-dimensional form (comprising lectures and videos, for example) that are readily formatted for sharing across a computer network. Such a two-dimensional presentation can create a gap in the student's understanding of how to apply what is learned to real life.

Additionally, it is reasonable to consider that various subjects would be more effectively presented in 3D form, providing a “real world” foundation that enhances the learning experience. For example, certain scientific studies that include laboratory experimentation and analysis of 3D objects face difficulties in being fairly represented in today's conventional 2D distance-learning environment.

Furthermore, students have a range of backgrounds, experiences, and learning abilities; as such, a learning platform that is inclusive of this variety by providing access to 3D tools and content that engages all of the senses is considered to be preferable in reaching a larger base of students worldwide.

### SUMMARY OF THE INVENTION

The needs remaining in the prior art are addressed by the present invention, which relates to on-line instructional systems and, more particularly, to such systems that incorporate 3D tools and analytics-based monitoring to create an individual learning environment suitable for all students, regardless of their physical location.

In accordance with the principles of the present invention, a “learning platform” is configured as a network element that may be accessed by a student, who interacts with various modules in a knowledge base, as well as associated analytics, to receive instruction across a wide range of subject matter areas. A 3D imaging system located at the learning platform interacts with the knowledge base and analytics module to create the various 3D projections as incorporated within each learning module to enhance a student's comprehension of a given topic.

Advantageously, the inventive learning platform is configured to create a holistic learning environment, providing supplemental information in the form of context, current events, depth of subject matter, inter-disciplinary learnings, and the like. The student-based data collected by the learning platform may be used in a variety of ways, such as to discern a best “learning style” for a given student, creating an on-line community of individual students with similar interests that may live on different continents, and the like.

An exemplary embodiment of the present invention takes the form of an on-line instructional system utilizing 3D image capabilities for enhancing the learning experience. In particular, the on-line instructional system comprises a learning platform implemented as a communication network element, the learning platform including a service management component for controlling access to the learning platform such that only subscribed students are permitted to participate in on-line instruction, a knowledge base including a plurality of separate databases, each database associated with a different academic discipline and including a plurality of individual lesson modules including one or more interactive 3D objects, and a 3D imaging system coupled to the knowledge base, the 3D imaging system configured to identify interactive 3D objects associated with an on-going instruction session and provide capability of 3D object manipulation by a subscribed student of the on-line instructional system.

Other and further aspects and advantages of the present invention will become apparent during the course of the following discussion and by reference to the accompanying drawings.

### BRIEF DESCRIPTION OF THE DRAWINGS

Referring now to the drawings,

FIG. 1 is a diagram of an exemplary network within which the learning platform of the present invention may be implemented;

FIG. 2 depicts an exemplary classroom setting that is equipped to utilize the 3D-enhanced on-line learning system of the present invention;

FIG. 3 illustrates an exemplary specialized laptop and 3D glasses combination that may be used by an individual student to interact with the inventive learning platform;

FIG. 4 illustrates an alternative of a specialized laptop and “3D mouse” combination that may be used by an individual student to interact with the inventive learning platform;

FIG. 5 illustrates another type of student configuration for interacting with the inventive learning platform, in this case using a conventional laptop device that is paired with a ‘smartphone’ including a downloaded app to assist in 2D/3D conversion;

FIG. 6 is a rear view of the arrangement of FIG. 5, illustrating an exemplary interface component that interacts with the smartphone and the graphic display electronics to provide 3D projection; FIG. 7 shows a student wearing 3D glasses and interacting with a wall-mounted 3D display, perhaps in a classroom setting;

FIG. 8 is an exemplary type of 3D object, here a biological object, that may be manipulated by a student during a learning session, in accordance with the principles of the present invention;

FIG. 9 shows a different type of 3D object, here an illustration of charges within a molecular structure, with separate components that may be brought closer together or moved further apart, under a student's control;

FIG. 10 is a GUI of an exemplary subject matter database (here, a “chemistry” database), as contained within the “science” discipline of the knowledge base at the inventive learning platform;

FIG. 11 is a GUI of an exemplary learning module within the chemistry database page shown in FIG. 10;

FIG. 12 depicts an alternative presentation of interdisciplinary material along a timeline;

FIG. 13 depicts another type of presentation, in this case in the form of a matrix of separate elements;

FIG. 14 illustrates a “mind map” that may be used as another tool for presenting material in a way that is best comprehended by some students; and

FIG. 15 is a GUI of an exemplary type of student report that may be generated by the analytics module within the inventive learning platform, showing an individual student's progress through the on-line learning system.

### DETAILED DESCRIPTION

A significant improvement in on-line learning situations is provided in accordance with the principles of the present invention in the form of 3D instructional capabilities and an interactive knowledge base driven by analytic processes. Opening up the third dimension for students via 3D technology, while also providing a holistic approach using the senses (e.g., touch, video, audio), results in a solution that will help students learn more efficiently and develop a deeper understanding through self-guided discovery, as well as teacher-guided learning.

In accordance with the present invention, a plurality of 3D tools and capabilities are provided for use by a student at his/her location. Additionally, a “learning platform” is configured as a network element that may be accessed by a student, who interacts with various modules in a knowledge base, as well as associated analytics, to receive instruction across a wide range of subject matter areas. The learning platform is configured to provide content in a personalized manner for each student, as will be described in detail below.

Advantageously, the learning platform of the present invention is also applicable for use in a “small group”/classroom setting, with individual students and an on-site instructor all having access to the 3D-presented content and ability to interact with various objects and manipulatives. The ability to bring such a classroom experience to areas around the world that have limited “local” educational resources is invaluable.

As will be discussed in detail below, the on-line instructional system of the present invention is based upon a network-connected learning platform that includes a “knowledge base” of learning modules that have been specifically developed to not only present the substantive material, but also provide different options for how to interact with the material, allowing for an individual student to utilize his/her best learning style for best comprehension of the particular material being presented. The knowledge base interacts in an on-going basis with a “3D imaging system” that is able to configure (perhaps in real time) certain subject matter for a specific student, without needing the student to have extensive 3D capabilities at his/her location. An analytics tool is an important module also included in the learning platform, where the analytics tool is used to monitor all aspects of a student's learning experience and pro-actively modify the sequencing or presentation style of certain material (for example) when trends indicate that the student is having difficulties with a specific subject.

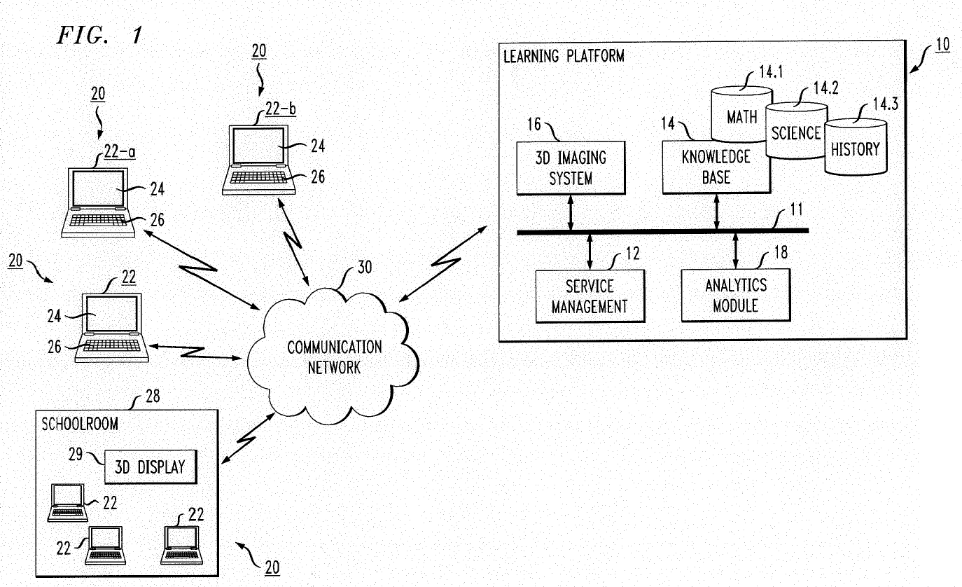

FIG. 1 is a diagram of an exemplary network within which a learning platform 10 formed in accordance with the present invention may be implemented and utilized to provide instruction at virtually any location and in various types of environments. The term “environments” is intended to include an individual student working on his/her own, a classroom setting, a small-group or tutorial gathering, and the like; indeed, any place where a student has access to learning platform 10 via a network-enabled device that preferably includes a display unit and a data entry device.

In particular, FIG. 1 illustrates learning platform 10 as comprising various components that interact with each other and the users. In accordance with the principles of the present invention and as will be discussed in detail below, learning platform 10 comprises a service management component 12, a knowledge base 14, a 3D imaging system 16 and an analytics module 18, where these various components are shown in this exemplary embodiment as interacting with each other via a common communication bus 11.

While each of these individual components will be discussed in detail below, it is to be understood that the inter-operability of each component to share tasks and modify aspects of a student's learning experience in real time is based upon the continual sharing of information among the various components.

Service management component 12 is primarily used for controlling access to learning platform 10, including not only general access in the first instance, but also managing various access levels and capabilities/functionalities available to different users. For example, some students may have access to only selected learning modules, or may only be able to implement and use certain 3D tools (the latter perhaps as a function of the type of device that the student is using). Certain schools, learning centers, communities, or the like may have different levels of subscription, depending on the needs in their specific learning environments. While not shown in detail, it is contemplated that services management component 12 includes individual elements that perform user verification, record and store access history logs, monitor subscription records, and the like.

Knowledge base 14 of learning platform 10 is a foundational component of the on-line instructional system of the present invention. In particular, knowledge base 14 includes sets of learning modules developed for a number of well-defined academic disciplines. For explanatory purposes only (and thus not considered to limit the scope of the applicability of the present invention), knowledge base 14 is shown in FIG. 1 as including sets of learning modules for the disciplines of mathematics, science, and history. Shown as database systems 14.1, 14.2, and 14.3, respectively, each general discipline area is further divided into different subject matter areas, with topics defined for each subject matter area, and learning modules (typically including a multiple number of individual learning sessions) associated with each subject matter area.

Under the control of the learning platform service provider, knowledge base 14 is created, updated, and managed to provide relevant and thorough teaching aids for numerous subjects. Indeed, it is an advantage of the learning platform of the present invention that knowledge base 14 may be configured to include presentations from reputable experts on various subjects, where such information would not be available to most students in a conventional classroom environment, let alone in regions around the world that have minimal access to facilities such as museums, universities, concert halls, and the like.

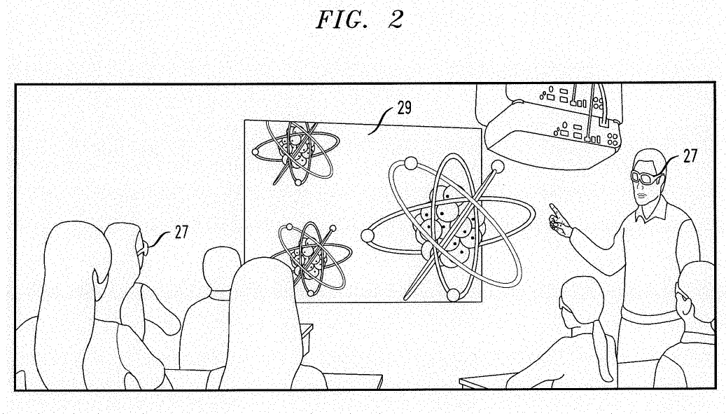

3D imaging system 16, also included in learning platform 10, is a foundational aspect of the present invention, providing the ability to add the third dimension to the presented material and giving the student a more “real world” setting within which to learn the material being presented. As discussed below, 3D imaging system 16 is particularly configured to allow a student to manipulate 3D objects included within a lesson. Indeed, as mentioned above, a significant aspect of the present invention is the providing of 3D tools for enhancing the learning experience (i.e., “breaking through” the barrier of a computer display screen) to engage with a student in this real-world fashion. FIGS. 2-9, discussed in detail below, are illustrative of various aspects of providing 3D capabilities to enhance a student's learning environment.

Continuing with the description of learning platform 10 as shown in FIG. 1, analytics module 18 is used to assess a student's progress in a course of study, administer tests, and collect data on an individual student's areas of interest, learning style(s), and the like. The collected information may be used in real-time to modify a particular study sequence, inject additional learning modules to reinforce a particular aspect, etc. The historical data may be evaluated to discover trends in an individual's learning style, ascertain specific areas of interest to a student (and suggest related topics), etc. As will be discussed below, analytics module 18 (perhaps in combination with service management component 12) may identify extra-curricular opportunities for students (e.g., suggest a local museum to visit, identify other students in the same geographic area with a common interest, etc.).

It is to be understood that the various components included within learning platform 10 may be organized in several different configurations, the specific arrangement shown in FIG. 1, illustrating each element to interact with each other via a common communication bus 11 being exemplary only and for the purposes of understanding the subject matter of the present invention.

FIG. 1 further depicts several individual student locations 20, which may be geographically dispersed around the world, where each location 20 utilizes a smart device 22 to interact with learning platform 10 via a communication network 30 (such as the internet, or any suitable public or private communication network). A smart device 22 may take the form of a laptop, tablet, smartphone, or the like, including a display 24 and data entry capabilities 26 (such as a keyboard).

As mentioned above, one aspect of the present invention is the ability to use/access learning platform 10 in a classroom environment. This classroom access capability is depicted as a schoolroom 28, which may utilize a single 3D display 29 for involvement with a classroom of students. Schoolroom 28 may also provide access to learning platform 10 via several smart devices 22 (for the sake of brevity, “smart devices 22” will be described below as “laptop 22”, with the understanding that other types of display/data entry devices may serve the same purpose).

FIG. 2 illustrates a particular classroom arrangement, using a single 3D display 29 to present instructional material to several students. In order to best utilize the 3D capabilities of display 29, the students (and instructor) use 3D glasses 27 to create the spatial imagery of the presentation.

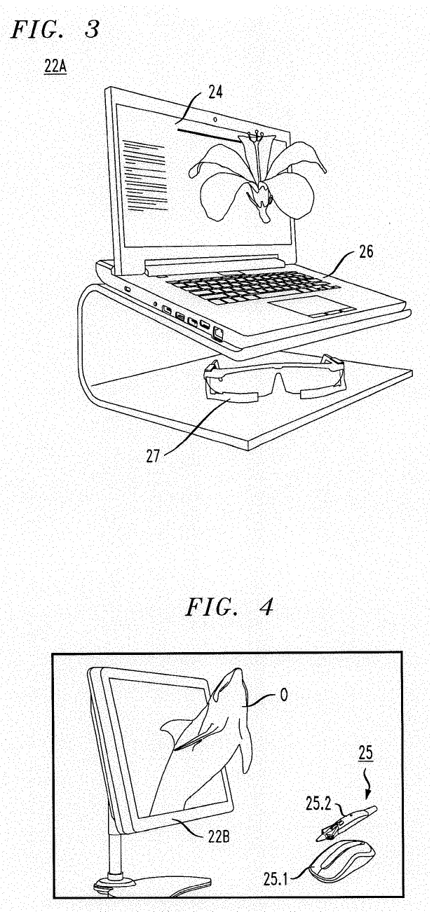

The ability to provide 3D-based activities as part of a learning session is considered to be a significant advantage of the present invention, which takes the form of using 3D imaging system 16 to interact with various types of user devices and enable bi-directional control of 3D objects presented as part of a particular lesson. For example and as shown in FIG. 3, a laptop 22A may be “paired” with 3D glasses 27 to provide a 3D-enabled learning environment. This configuration requires that laptop 22A be configured to communicate with glasses 27 to create 3D objects that may be selected and manipulated (using techniques known in the art as, for example, shutter control of left/right images to provide a 3D image).

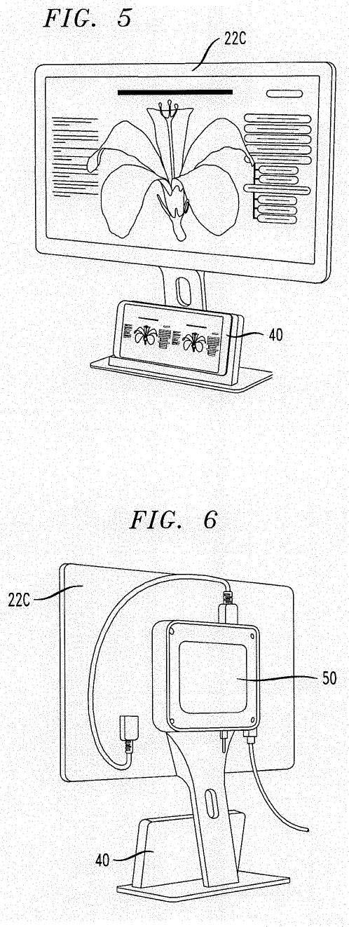

In another embodiment, a 3D communication device (such as a 3D “mouse”) may be used to control an interactive presentation via learning platform 10 in accordance with the principles of the present invention. Details on exemplary 3D communication devices may be found in our co-pending application Serial No. PCT/US19/21070, filed Mar. 7, 2019 and herein incorporated by reference. FIG. 4 illustrates a 3D mouse 25 that is paired with a laptop 22B and used to create movement in 3D space that will manipulate a displayed object O. 3D mouse 25 is shown in this particular configuration as including a base element 25.1 that primarily functions as a traditional mouse, and a pen element 25.2 that may engage with base element 25.1, or be lifted away and used as a “wand” that sends three-dimensional (spatial) commands to laptop 22B (for example, to first “select” and then “control” object O). Our above-referenced, co-pending application Serial No. PCT/US10/21070 describes in detail various types of 3D-enabled mouse devices that may be used for this purpose.

While useful, the worldwide reach of sensory-based learning may be limited by the need for laptop devices with advanced graphic capabilities for producing a 3D display as shown in FIGS. 3 and 4. Thus, another aspect of the present invention is the capability of providing a set of 3D tools that may be used in conjunction with a conventional computer display.

FIG. 5 is a front view of a conventional (2D) display device 22C that may be paired with a user's “smart” device 40 (such as a phone or tablet) to eliminate the need for a 3D-configured laptop device (such as devices 22A and 22B of FIGS. 3 and 4). FIG. 6 is a rear view of the configuration shown in FIG. 5, particularly showing an interface device 50 that is included and used to provide the necessary mapping between 2D and 3D graphics. Our co-pending application Serial No. PCT/US19/57284, filed Oct. 21, 2019 describes the details of various types of interfaces that may be utilized to allow for conventional (2D) display devices to be enabled and used as 3D learning tools.

In various embodiments of the present invention, a student's gestures may be used to control the manipulation of 3D objects as projected on a display, in this case eliminating the need for the student to utilize a mouse, keyboard or touchscreen. In this manner, students in remote locations that otherwise lack access to certain tools and experiences are able to have a more “hands-on” learning experience. For example, a student studying anatomy may be able to “hold”, and “rotate” a 3D display of a human heart to gain a greater understanding of its details. FIG. 7 illustrates this possibility. A student wearing 3D glasses 27 is shown as controlling the movement of a 3D object O as projected by display device 29. Cameras 60 mounted in glasses 27, as well as one or more cameras 62 mounted on display device 29, are able to monitor hand gesture movements (and perhaps eye movements) to allow for gesture-based manipulation of object O.

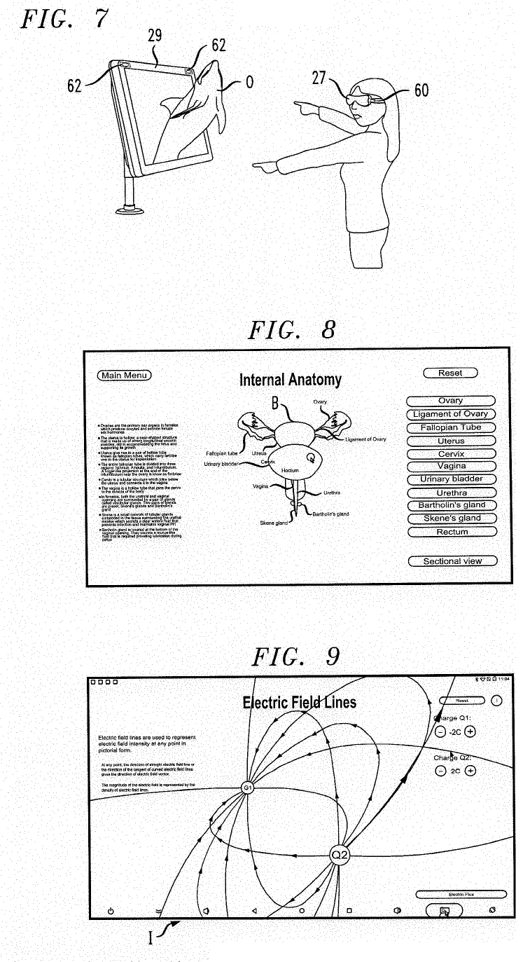

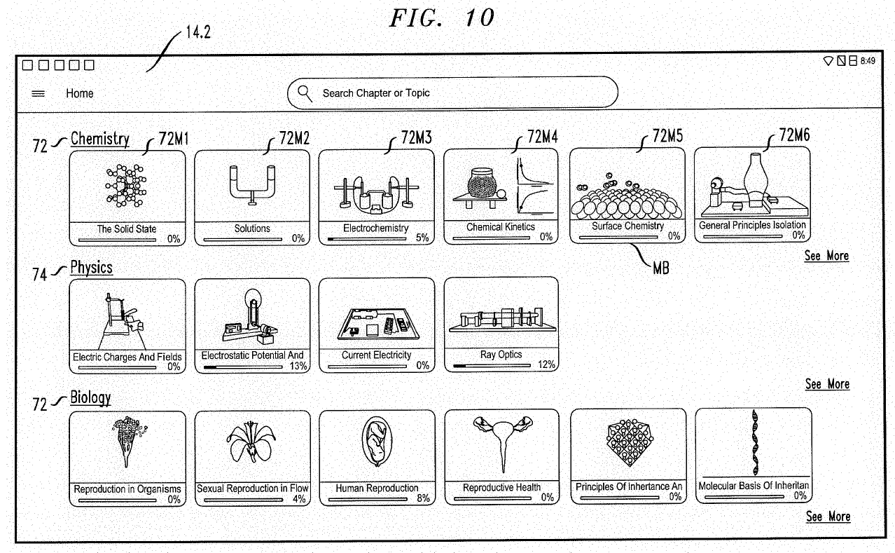

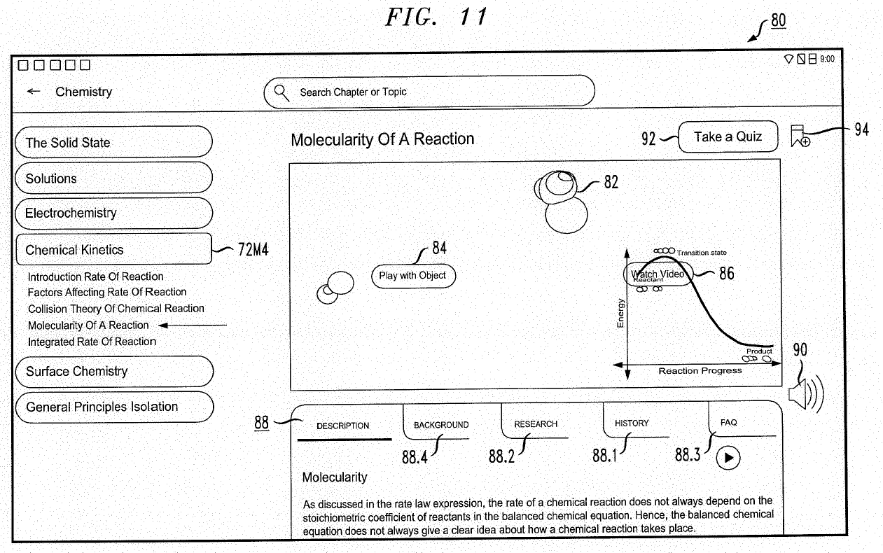

Continuing with a discussion of the benefits of implementing 3D tools in an on-line learning experience, FIGS. 8 and 9 show exemplary GUIs that may be manipulated using 3D technology (via 3D imaging system 16 of learning platform 10) to enhance a computer-based learning experience. FIG. 8 depicts the internal anatomy of a biological system B which may be “held”, and “manipulated” in the manner described above to gain a greater understanding of its details. In accordance with the present invention, the 3D manipulation may be paired with knowledge base 14 so as to provide different types of detailed information, depending upon the view. FIG. 9 illustrates a different type of image I that may be manipulated to improve the learning experience. Here, a student can manipulate the spacing between two charges, and see how the change in spacing affects the electric field lines.

While not exhaustive, the various features shown in FIGS. 2-9 are considered to be illustrative of the provision of 3D tools (via 3D imaging system 16) in accordance with the principles of the present invention. However, without the ability to provide access to an extensive library of learning modules across a wide variety of disciplines, 3D tools may be entertaining for the user, but of little impact in improving on-line instruction.

Thus, a significant aspect of the present invention is the provision of knowledge base 14 that is regularly updated to maintain timeliness of the presented material, and includes “vetted” material presented by subject matter experts. Additionally, the learning modules are particularly configured to leverage the capabilities of the 3D tools to enhance the learning experience.

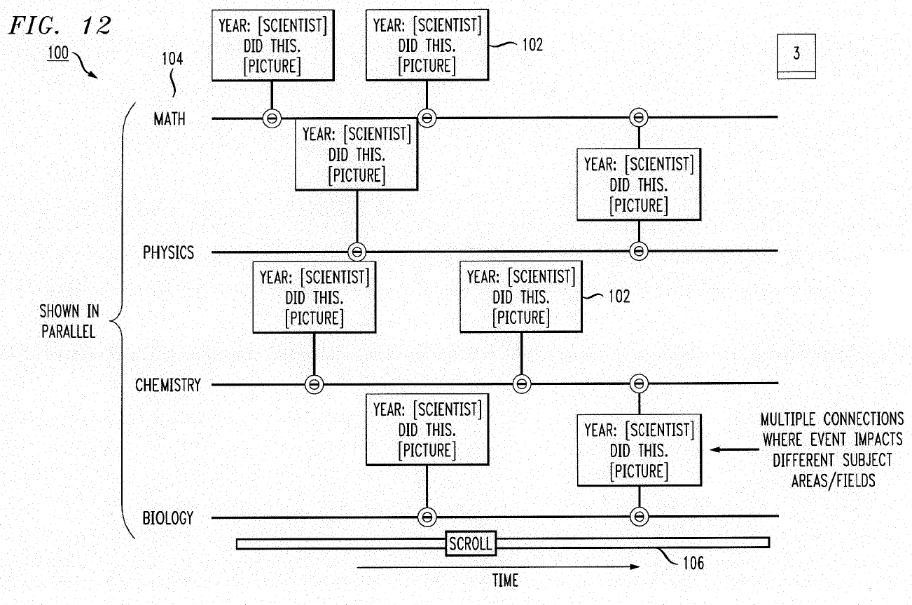

FIG. 10 illustrates an exemplary page 70 from knowledge base 14 as displayed for a student. In this example, page 70 is an introductory page from “science general discipline database system 14.2 of knowledge base 14 (as discussed above in association with FIG. 1). In this particular arrangement, science database system 14.2 includes several different subject matter areas, visually presented on page 70 as (for example) “Chemistry” 72, “Physics” 74, and “Biology” 76. Each subject matter is shown as including a set of different learning modules, with a graphic identification of each learning module shown in relation to its subject matter area.

For example, Chemistry 72 is shown in the illustration of FIG. 10 as including a module 72M1 entitled “The Solid State”, a module 72M2 entitled “Solutions”, 72M3 entitled “Electrochemistry”, 72M4 entitled “Chemical Kinetics”, 72M5 entitled “Surface Chemistry” and 72M6 entitled “General Principles Isolation”. Associated with each graphic illustration is a completion bar MB showing that student's specific progress through various modules.

For the purposes of illustration, it is presumed that a student has selected module 72M4 “Chemical Kinetics” for instruction. As with conventional computer-based interactive systems, the student may utilize one or more of keyboard, mouse, voice, touch, or movement controls to activate this particular module. FIG. 11 presents a GUI 80 for a selected page within module 72M4, the selected page associated with “Molecularity Of A Reaction”. Various aspects of the interactions between knowledge base 14, 3D imaging system 16, and analytics module 18 are understood from a review of this illustration. For example, the ability to directly interact with a 3D object 82 is shown as prompt 84 in FIG. 8 (“Play with 3D object”), which then accesses and utilizes 3D imaging system 16. A video prompt 86, associated with a graph of a reaction process is also available for use by a student, where when activated the video will “play” the change in molecular energy as a function of reaction progress, following the plot as shown in the graph. Menu bar 88 shows a set of topics that provide a fluid, dynamic and interactive learning session for the student. Succinct additions that bring together other important aspects associated with a full understanding of a particular concept are available via menu bar 88, such as via “History” tab 88.1, “Research” tab 88.2, and FAQ tab 88.3 (as well as basic instructional information in terms of description and background information). Indeed a feature that may be enabled via a “Background” tab 88.4 contains links to other topic modules within knowledge base 14 that are related to a given topic. Accordingly, this allows for different subjects, as well as prior lessons on a related theme, to be connected in an easy manner for the students to access without the student required to actually determine what other information may be “out there”. All of this supplemental information is provided by knowledge base 14. It is also possible to provide an audio-guided learning capability 90, for use by students that exhibit a learning style that best responds to audio instruction.

Also shown in FIG. 11 is a quiz link 92, which takes the student to a proper location in analytics module 18 that presents a set of questions appropriate for that particular learning module. A “notes” portion 94 of GUI 80 allows for a student to enter his/her own question, and receive a response. Advantageously, analytics module 18 is able to assess an individual student's level of understanding and preferred learning style(s) in order to provide a response that best communicates the answer in a way that will be fully comprehended by the student.

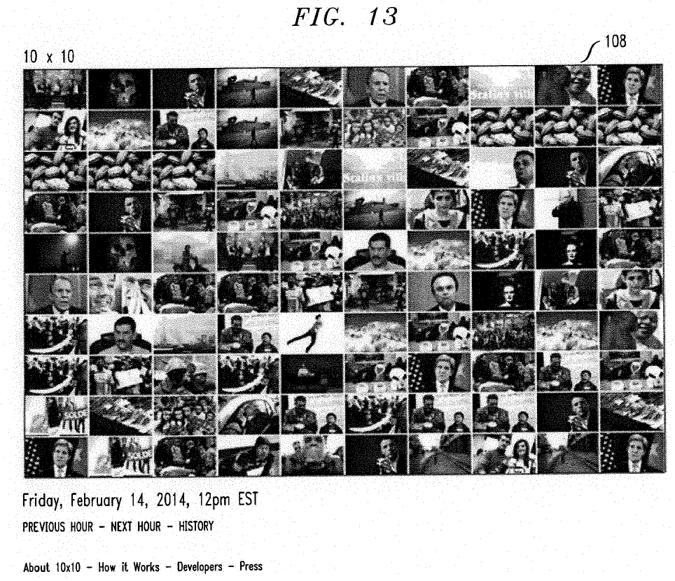

Advantageously, learning platform 10 is configured to create a holistic learning environment, providing supplemental information in the form of context, current events, depth of subject matter, inter-disciplinary learnings, and the like. FIG. 12 illustrates an exemplary history timeline 100 that may be displayed for a student, providing a visual tool to analyze relationships between events in different disciplines (here, math, physics, chemistry, and biology) over time. Each box 102 is an active link that will take a student to a detailed discussion of the selected item. As also shown in FIG. 12, this data set may be displayed in an interactive matrix form of “subjects” 104 vs. “time” 106, with each individual “unit” 102 accessible by the student.

An additoinal aspect of the present invention involves the ability of analytics module 18 in combination with services management component 12 to use a specific student's geographical location to supplement the learning environment. For example, a student resident in the Chicago area and interested in the “unified field theory” may be sent a message about an upcoming lecture at the University of Chicago on this subject. A student in the Dallas area interested in bio-fuel development may receive a message regarding a conference on alternative energy sources scheduled for the following week in Ft. Worth.

The capabilities of service management component 12 to track physical locations of students, coupled with the abilities of analytics module 18 to create an information of a student's areas of interest, allow for learning platform 10 to expand the context of instruction beyond the on-line tools.

Another community-based tool is the capability of service management component 12 and analytics module 18 to process area and interest information for multiple students in a manner that allows for the identification of various “interest groups” of subscribed students. For example, the student associated with device 22-a of FIG. 1 and the student associated with device 22-b of FIG. 1 may both be studying AP Calculus. Learning platform 10 may be configured to allow for an exchange of information between these students (and perhaps others) to form a “study group”. Indeed, it is further possible to utilize analytics module 18 to find a group of students in the same geographic area that may form a study group that meets in person, adding further context to the learning process.

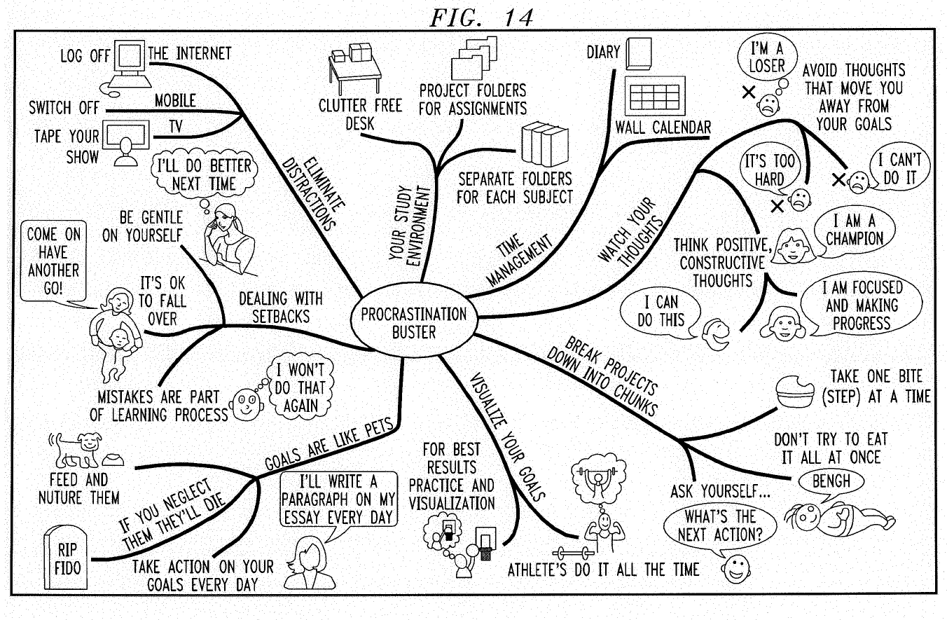

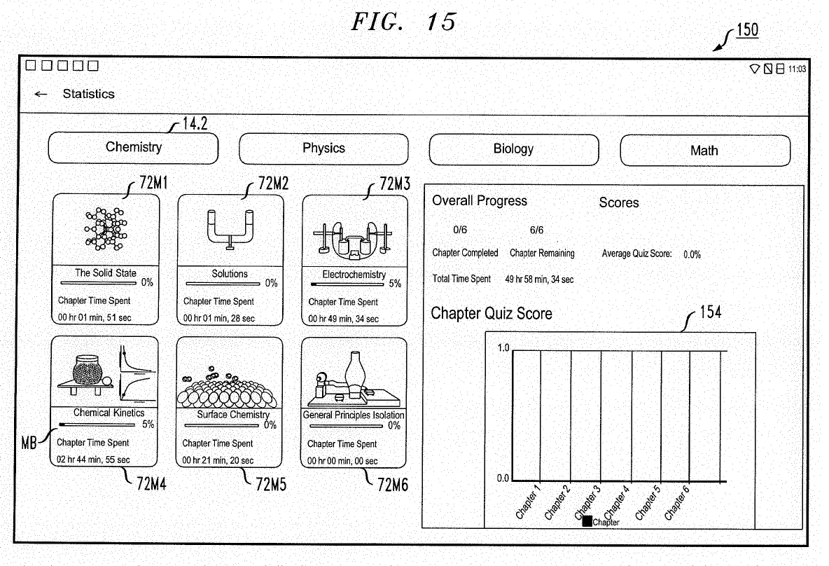

While a significant portion of a sensory-based learning experience involves the “touch” sense and 3D manipulation of objects, it is to be understood that other aspects of the present invention relate to various types of visual and audio presentations of instructional material. FIGS. 13 and 14 illustrate two “visual” alternatives of material presentation. In particular, FIG. 13 illustrates an exemplary matrix-based presentation 108 of a variety of specific elements within a given learning module. FIG. 14 illustrates a “mind map” presentation 109 that utilizes a different type of learning style to enhance a student's ability to fully understand the material being presented. Depending on the learning/organizational skills of a particular student, the presentation of material in one (or others) of these visual constructs enhances their ability to efficiently and effectively assimilate the subject matter being presented.

Audio-enhanced learning is another tool that may be used in several ways. For example, infusing certain types of music into the learning experience may assist with a particular student's ability to focus on a computer-based activity. The volume of the infused music may further be controlled to assist in this endeavor. Audio-enhanced learning may also take the form of listening to a presentation of the material itself, as discussed above in association with FIG. 11 and the inclusion of “audio” resource 90 for presenting (for example) a pre-recorded lecture on the subject of the “molecularity of a reaction”. Supplemental audio information, such as lectures by famous professors, speeches by political leaders, and the like, may all be used to enrich the sensory-based learning experience of the present invention.

Another significant aspect of the present invention is the ability to utilize analytics module 18 to provide real-time assessment of a student's progress through one or more portions of knowledge base 14. This information is contemplated to be accessible not only by the student, but by teachers and program administrators. In the case where primary and secondary students are utilizing the learning platform, parents/guardians may access this information as well.

FIG. 15 is a GUI illustration of an exemplary “statistics” page 150, which in this case shows a high-level evaluation of a student's progress through the chemistry database portion 14.2 of knowledge base 14. The exemplary organization shown in FIG. 15 indicates the plurality of specific learning modules 72M1-72M6, as well as percentage of completion MB of each module. A separate area 154 is used to illustrate test scores. Inasmuch as it is possible to track the time spent studying each individual module (and even individual components (such as “history” or “research” under tabs 88.1, 88.2 within menu 88 of each module), analytics module 18 is able to provide information regarding how long a student has spent involved in each topic. Because of the connections and links that learning platform 10 makes between different subjects through the information presented in the various menu selections “background”, “FAQs”, “history”, and “research”, the interdisciplinary inclination (as well as the multidisciplinary inclination) of each student may also be gleaned This information may be used in conjunction with specific analytics to develop a more detailed understanding of specific topics of interest to a given student, which may then be used to suggest supplemental sources of information to expand on the student's understanding of how the concepts that particularly interest him or her are applied or presented outside of a schooling environment, in the real world (such as museums, universities current research, experts in the field, potential career paths), as described above. Advanced analytical tools may also be used to monitor the specific types of learnings that best assist a given student, and supplement future modules with similar types of tools (e.g., additional videos).

This collected information in terms of time spent, preferred learning styles and tools, etc. can all be organized and presented in various forms, such as 3D graphical breakdown illustrating peaks that are correlated to time/energy spent per subject/day/month, or any other quantifiable set of metrics. The ability to report this type of information is useful in presentations to the student, as well as parents and teachers. Indeed, the use of analytics module 18 to evaluate a student's interactions with learning platform 10 is able to determine areas where a student is struggling, and then utilize advanced analytics to suggest other content modules and/or learning tools and styles that can augment the student's fundamental understanding of the topic.

Additionally, the ability to monitor and track modules and courses that have been mastered by a student allows for the system of the present invention to “flag” any missing pre-requisites a student may have for an advanced topic, and suggest modules that may be utilized to fulfill that requirement. In terms of preparation for college, the learning platform may be used to ensure that a given student has mastered the necessary courses.

It is contemplated that this utilization of analytics module 18 thus provides a personalized learning environment, which may be further enhanced with external activities such as study groups, trips to museums, and the like. Indeed, these advanced analytics may also be used, as mentioned above, to supplement learning in areas of interest for a particular student (where analytics module 18 is used to determine these areas of interest). Again, suggestions may be location-based, including university activities, available experts in a given field, and the like.

Indeed, these advanced analytics may also be used, as mentioned above, to supplement learning in areas of interest for a particular student (where analytics module 18 is used to determine these areas of interest). Again, suggestions may be location-based, including university activities, available experts in a given field, and the like.

It is intended that the environment of presentations provided by learning platform 10 is dynamic and fluid, allowing for different modules to be sequenced in different orders for specific students. The presentation mode is automatically adjusted, via analytics module 18, based on a student's educational needs, struggles and emphasis, providing a “personalized” learning environment.

While the present invention has been discussed in connection with preferred embodiments, it will be understood that various modifications will be readily apparent to those skilled in the art. Thus, the present disclosure is intended to be exemplary only, with the scope of the present invention covering any adaptations or variations thereof. For example, different labels for the various features, screen sections, and database organizations may be used without departing from the scope of the invention. Indeed, this invention should be limited only by the claims appended hereto, and equivalents thereof.

What is claimed is:

1. An on-line instructional system utilizing 3D image capabilities for enhancing a learning experience, the on-line instructional system comprising
a learning platform implemented as a communication network element for interacting with a student communication device over a network, the learning platform including
a service management component for controlling access to the learning platform such that only a subscribed student is permitted to participate in on-line instruction
a knowledge base including a plurality of separate databases, each database associated with a different academic discipline and including a plurality of individual lesson modules including one or more interactive 3D objects;
a 3D imaging system coupled to the knowledge base, the 3D imaging system configured to identify interactive 3D objects associated with an on-going instruction session and provide capability of 3D object manipulation via the student communication device associated with the subscribed student of the on-line instructional system.

2. The on-line instructional system as defined in claim 1 wherein the learning platform further includes
an analytics module for collecting student data and providing reports on a subscribed student's progression through one or more academic disciplines.

3. The on-line instructional system as defined in claim 2 wherein the analytics module is in communication with the service management component to provide controlled access to selected areas of the knowledge base as a function of the subscribed student's performance.

4. The on-line instructional system as defined in claim 2 wherein the analytics module further includes processors for administering tests to students upon completion of learning modules and performing data analysis of test results for developing student-based information.

5. The on-line instructional system as defined in claim 4 wherein the student-based information includes identification of learning styles, subjects needing further instruction, areas of interest.

6. The on-line instructional system as defined in claim 1, wherein the on-line instructional system further comprises
one or more student communication devices including a 3D-enabled display and a capability to interact with the learning platform over a communication network.

7. The on-line instructional system as defined in claim 1 wherein the knowledge base is continuously updated by an on-line instructional system service provide.

8. The on-line instructional system as defined in claim 1 wherein one or more of the plurality of individual lesson modules further comprises interactive video presentations.

9. The on-line instructional system as defined in claim 1 wherein the service management component communicates with the analytics module to identify subscribed students at disparate locations with a common interest in a specific academic discipline.

10. The on-line instructional system as defined in claim 1 wherein the service management component communicates with the analytics module and the knowledge base to determine a subscribed student's physical location and one or more extracurricular programs in geographic proximity to the subscribed student's physical location.
